(19) United States
(12) Patent Application Publication
(10) Pub. No.: US 2017/0277691 A1
(43) Pub. Date: Sep. 28, 2017

(54) Quantifying Social Influence

(71) Applicant: Facebook, Inc., Menlo Park, CA (US)

(72) Inventor: Nipun Agarwal, Fremont, CA (US)

(21) Appl. No.: 15/077,679

(22) Filed: Mar. 22, 2016

(51) Int. Cl. G06F 17/30; H04L 29/08

(52) U.S. Cl. CPC G06F 17/3053; H04L 67/22

(57) ABSTRACT

In one embodiment, a method includes receiving social network data associated with a first user of one or more social-networking systems, calculating one or more social influence factors for the first user based on the social network data, where the social influence factors include a size of the first user's audience on the social-networking systems and one or more content-related factors based on social media content generated by the first user on the social-networking systems, determining a social influence score of the first user based upon the social influence factors, and performing an action based on the social influence score of the first user. The social network data may include one or more sizes of the first user's audience on each of the corresponding social-networking systems, and the size of the first user's audience may be based on a sum of the audience sizes.

### TECHNICAL FIELD

This disclosure generally relates to quantifying characteristics of users of online social networks.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

Each user of an online social network may influence other users, e.g., by posting content that affects the opinions or actions of the other users. A user who has a large audience, posts content frequently, interacts with other users frequently, or is famous, such as a public figure or celebrity, may have greater influence on social-networking systems than less-well-known users. The social influence of a user may be quantified by generating a social influence score based on information about the user's audience and content the user posts or publishes on one or more social networking systems. The social influence score may be calculated by an algorithm based on one or more social influence factors, which may include the number of followers the user has, the quantity of content the user posts, the quantity of content published by other users and directed to the user, and quality of content posted by the user. In particular embodiments, the social influence score may be a weighted average of the social influence factors. The social influence score may be used, for example, to compare the levels of social influence of two different users, to enable users to assess their current influence and progress in increasing their influence over time, or to assess the effectiveness of the user's actions on the social-networking system on the user's social influence. The quantified social influence may also be used by operators of online social networks, e.g., for identifying disengaged users to contact and attempt to re-engage.

Actions may be performed by the social-networking system based on the social influence score of a user. For example, the social influence score may be used to measure progress made by a user toward a goal, such as having at least a specified number of followers. The social networking system may automatically perform actions to increase or maintain a user's social influence score. In particular embodiments, a social influence scoring algorithm may be generated by identifying values of the social influence factors that are correlated to increases or decreases in desired outcomes such as high attendance at events or increased advertising revenue, and adjusting the algorithm to produce respective increases or decreases in the social influence score that are correlated with the desired outcomes. The social influence scoring algorithm may subsequently be used to calculate a social influence score that can be used to evaluate the user's subsequent actions to determine whether the actions are likely to produce the desired outcomes.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3A illustrates an example embodiment of a system for quantifying social influence and performing actions based on the social influence.

FIG. 3B illustrates an example method for generating social influence scoring algorithms.

FIG. 4 illustrates example social influence factor values.

FIG. 5 illustrates example success factors.

FIG. 6 illustrates example social influence scores for equally-weighted social influence factors.

FIG. 7 illustrates example social influence scores for varying weightings of social influence factors with equally-weighted social-networking systems.

FIG. 8 illustrates example social influence scores for varying weightings of social influence factors with social-networking systems weighted by number of users.

FIG. 9 illustrates an example method for quantifying social influence and performing actions based on the social influence.

FIG. 10 illustrates an example method for selecting a social-influence scoring algorithm.

FIG. 11 illustrates an example computer system.

### DESCRIPTION OF EXAMPLE EMBODIMENTS

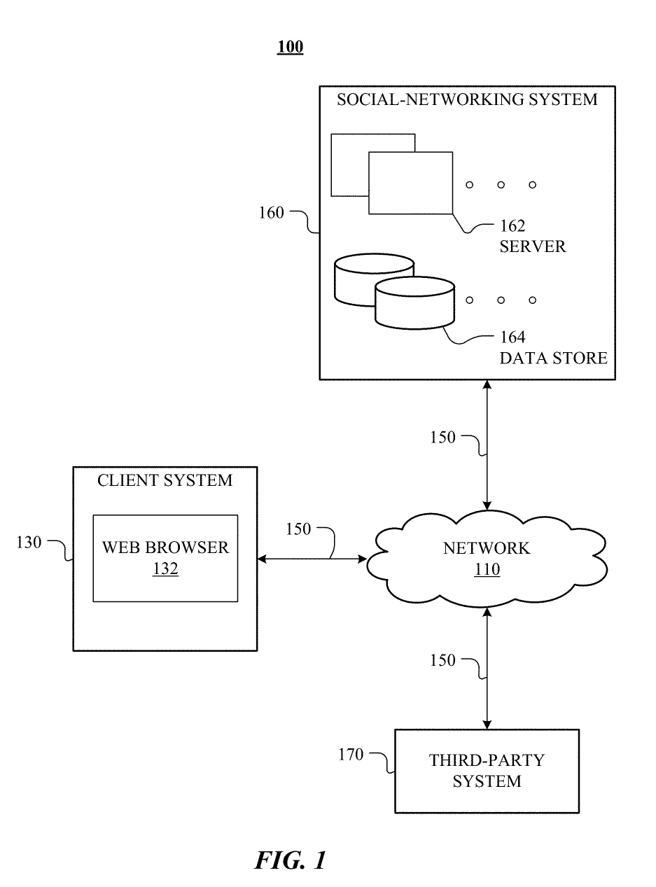

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, client system 130 may access social-networking system 160 using a web browser 132, or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 to whom they want to be connected. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

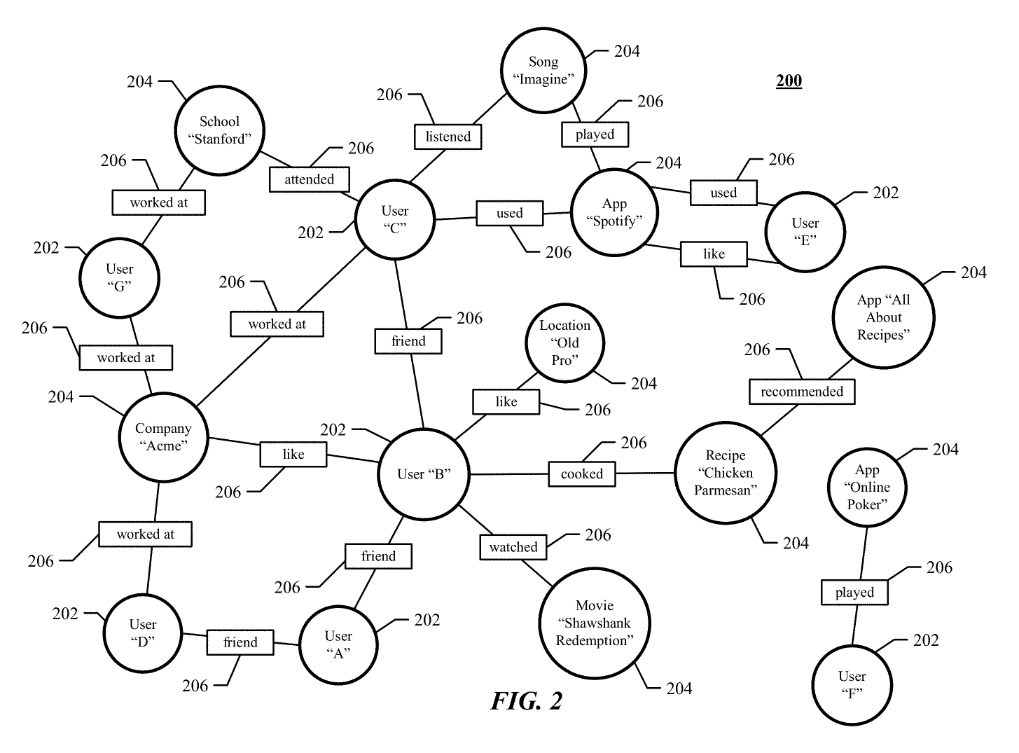

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more web pages, in one or more e-mails, or in connection with search results requested by a user. In addition or as an alternative, an advertisement may be one or more sponsored stories (e.g., a news-feed or ticker item on social-networking system 160). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system 160. In addition or as an alternative, the social action may be promoted outside or off of social-networking system 160, where appropriate. In particular embodiments, a page may be an on-line presence (such as a webpage or website within or outside of social-networking system 160) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 160. Sponsored stories are more likely to be viewed by users, at least in part because sponsored stories generally involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. Patent Application Publication No. 2012/0203831, entitled “Sponsored Stories Unit Creation from Organic Activity Stream” and filed 3 Feb. 2012 as U.S. patent application Ser. No. 13/020,745, or U.S. Patent Application Publication No. 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation.

As described above, an advertisement may be text (which may be HTML-linked), one or more images (which may be HTML-linked), one or more videos, audio, one or more ADOBE FLASH files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. An advertisement may be displayed within dedicated pages, requiring the user to interact with or watch the advertisement before the user may access a page, utilize an application, or play a game. The user may, for example view the advertisement through a web browser.

A user may interact with an advertisement in any suitable manner. The user may click or otherwise select the advertisement, and the advertisement may direct the user (or a browser or other application being used by the user) to a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 160) or RSVP (e.g., through social-networking system 160) to an event associated with the advertisement. In addition or as an alternative, an advertisement may include social-networking-system content directed to the user. For example, an advertisement may display information about a friend of the user within social-networking system 160 who has taken an action associated with the subject matter of the advertisement.

Social-networking-system functionality or content may be associated with an advertisement in any suitable manner. For example, an advertising system (which may include hardware, software, or both for receiving bids for advertisements and selecting advertisements in response) may retrieve social-networking functionality or content from social-networking system 160 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed 5 Oct. 2010 as U.S. patent application Ser. No. 12/898,662, and in U.S. Patent Application Publication No. 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 160.

Particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 160 to identify those users. In addition or as an alternative, social-networking system 160 may use user-profile information in social-networking system 160 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 160, off or outside of social-networking system 160, or on mobile computing devices of users. When on or within social-networking system 160, such targeting may be directed to users' news feeds, search results, e-mail or other in-boxes, or notifications channels or may appear in particular area of web pages of social-networking system 160, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 160, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 160 or explicit connections of a user to a node, object, entity, brand, or page on social-networking system 160. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193702; U.S. Patent Application Publication No. 2009/0070219, entitled “Targeting Advertisements in a Social Network” and filed 20 Aug. 2008 as U.S. patent application Ser. No. 12/195321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. 2012/0159635, entitled “Comment Plug-In for Third-Party System” and filed 15 Dec. 2010 as U.S. patent application Ser. No. 12/969,368; U.S. Patent Application Publication No. 2012/0158753, entitled “Comment Ordering System” and filed 15 Dec. 2010 as U.S. patent application Ser. No. 12/969408; U.S. Pat. No. 7,669,123, entitled “Dynamically Providing a News Feed About a User of a Social Network” and filed 11 Aug. 2006 as U.S. patent application Ser. No. 11/503,242; U.S. Pat. No. 8,402,094, entitled “Providing a Newsfeed Based on User Affinity for Entities and Monitored Actions in a Social Network Environment” and filed 11 Aug. 2006 as U.S. patent application Ser. No. 11/503,093; U.S. Patent Application Publication No. 2012/0072428, entitled “Action Clustering for News Feeds” and filed 16 Sep. 2010 as U.S. patent application Ser. No. 12/884,010; U.S. Patent Application Publication No. 2011/0004692, entitled “Gathering Information about Connections in a Social Networking Service” and filed 1 Jul. 2009 as U.S. patent application Ser. No. 12/496,606; U.S. Patent Application Publication No. 2008/0065701, entitled “Method and System for Tracking Changes to User Content in an Online Social Network” and filed 12 Sep. 2006 as U.S. patent application Ser. No. 11/531,154; U.S. Patent Application Publication No. 2008/0065604, entitled “Feeding Updates to Landing Pages of Users of an Online Social Network from External Sources” and filed 17 Jan. 2007 as U.S. patent application Ser. No. 11/624,088; U.S. Pat. No. 8,244,848, entitled “Integrated Social-Network Environment” and filed 19 Apr. 2010 as U.S. patent application Ser. No. 12/763,171; U.S. Patent Application Publication No. 2011/0083101, entitled “Sharing of Location-Based Content Item in Social-Networking Service” and filed 6 Oct. 2009 as U.S. patent application Ser. No. 12/574614; U.S. Pat. No. 8,150,844, entitled “Location Ranking Using Social-Graph Information” and filed 18 Aug. 2010 as U.S. patent application Ser. No. 12/858,718; U.S. patent application Ser. No. 13/051,286, entitled “Sending Notifications to Users Based on Users' Notification Tolerance Levels” and filed 18 Mar. 2011; U.S. patent application Ser. No. 13/096184, entitled “Managing Notifications Pushed to User Devices” and filed 28 Apr. 2011; U.S. patent application Ser. No. 13/276,248, entitled “Platform-Specific Notification Delivery Channel” and filed 18 Oct. 2011; or U.S. Patent Application Publication No. 2012/0197709, entitled “Mobile Advertisement with Social Component for Geo-Social Networking System” and filed 1 Feb. 2011 as U.S. patent application Ser. No. 13/019,061. Although this disclosure describes or illustrates particular advertisements being delivered in particular ways and in connection with particular content, this disclosure contemplates any suitable advertisements delivered in any suitable ways and in connection with any suitable content.

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user may make frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 200, social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by social-networking system 160 or shared with other systems (e.g., third-party system 170). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 162 may be authorization/privacy servers for enforcing privacy settings. In response to a request from a user (or other entity) for a particular object stored in a data store 164, social-networking system 160 may send a request to the data store 164 for the object. The request may identify the user associated with the request and may only be sent to the user (or a client system 130 of the user) if the authorization server determines that the user is authorized to access the object based on the privacy settings associated with the object. If the requesting user is not authorized to access the object, the authorization server may prevent the requested object from being retrieved from the data store 164, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

Each user of an online social network may influence other users, e.g., by posting content that affects the opinions or actions of the other users. A user who has a large audience, posts content frequently, interacts with other users frequently, or is famous, such as a public figure or celebrity, may have greater influence on social-networking systems than less well-known users. In particular embodiments, the social influence of a user may be quantified by generating a social influence score based on information about the user's audience and content the user posts or publishes on one or more social networking systems. The social influence score may be used, for example, to compare the levels of social influence of two different users, to enable users to assess their current influence and progress in increasing their influence over time, or to assess the effectiveness of different types of content and action on a user's social influence. The quantified social influence may also be used by operators of social-networking systems, e.g., to identify disengaged users to contact and attempt to re-engage, or to identify characteristics or usage patterns that are common among highly-engaged users.

In particular embodiments, the social influence score may be calculated based on one or more social influence factors, which may in turn be calculated based on data from one or more social networking system. Each social influence factor may be a measure of a particular aspect of the user's social influence, and the social influence score may be based on an average of the social influence factors. The social influence score may be a numeric value, such as an integer or floating-point number, and may be a value in a range, such as an integer between 1 and 100 or a floating-point number between 0 and 1. A social influence scoring algorithm may calculate the score using a mapping that maps the social influence factors to the social influence score. The mapping may be, for example, a linear weighted average, a list of one or more ranges of social influence factors and their corresponding social influence scores (specified as numeric values and/or as a function), a polynomial function generated using curve fitting based on historical values of the social influence factors, a mapping generated by a machine-learning algorithm trained on training data, or other type of mapping. The training data may include historical social influence data, historical social influence factor values, and/or historical values of desired results correlated in time with the historical data.

In particular embodiments, the social influence factors for a user may be determined based on data related to the user's activity on one or more social-networking systems. The social influence factors calculated for a user may include fan popularity (FP), content publishing (CP), content interaction (CI), and content quality (CQ). The fan popularity factor (FP) may be a measure of the size of the user's audience on the social-networking systems. In particular embodiments, the fan popularity factor may be determined based on a total number of fans or followers the user has on the one or more public social-networking systems. For example, the fan popularity factor may be determined by how many other users follow, subscribe to, or otherwise have an association with the user in which they receive content from the user on social-networking systems. A user's friends on a social-networking system may optionally be counted as followers of the user. The social-networking systems may include public social networking systems, social communication platforms, social media platforms, or the like. In particular embodiments, negative sentiment may be distinguished from positive sentiment. A negative “like” may have a different weight from a positive like when calculating fan popularity. Disagreements with the user's posts by other users may negatively influence the content interaction score. If there are at least a threshold number of negative likes associated with content posted by the user, then the user's social influence score may be reduced accordingly.

In particular embodiments, the content publishing factor (CP) may be a measure of the quantity of content the user publishes on social-networking systems, how frequently the user publishes content, the rate at which the user posts content, or the like. In particular embodiments, the content publishing factor may be determined based on the total volume of content generated by the user. The content included in the content publishing factor may be communicated from the user to his or her fans (one-way). The content may include original posts as well as follow-ups, comments, and other content created by the user.

In particular embodiments, the Content Interaction (CI) factor may be determined based on the total quantity or volume of content generated by the user and by fans (e.g., followers) of the user, how frequently the user interacts with his or her audience, the rate at which the user and the user's audience publish content, and/or the quantity of interactions between the user and the user's audience. Interactions may include any communications from the user to one or more fans, or from a fan to the user. Interactions may include likes, comments, shares, moments, photos, video replies, audio replies, links, @mentions, direct communication, and so on. Interactions may also be public figure to public figure interactions, public figure to fan, fan to public figure, or fan to fan interactions on a social media page or property of the public figure.

In particular embodiments, the content quality factor (CQ) may be a measure of authenticity of content the user posts, richness or depth of the content, or other measure of the quality of content the user posts, such as whether the content is promotional in nature. The content quality factor may be based on a measure of the authenticity of the content the user publishes. The content quality factor may also be based on authenticity of the topic of the content that the user publishes, and/or richness or depth of the content or its topic. The content quality factor may be based on how much of the content generated by the user is authentic and non-promotional. For example, the content quality may be a ratio of how much of the content generated by the user is promotional content such as “I have a new album out” or “Buy this album” versus how much of the content generated by the user describes issues that are important to the user and is original content authored by the user.

In particular embodiments, the social influence score may be a weighted average in which each of the social influence factors is weighted by a corresponding social influence weight. For example, the social influence factors may be weighted evenly when calculating the average, or one or more of the social influence factors may be weighted more heavily (e.g., higher) than others. Further, the social influence score may be calculated based on data from multiple social networking systems. For example, the social influence score may be based on an average of social influence scores, social influence factors, or other data from each of the social networking systems. The social influence score or social influence factors may be weighted averages in which each of the per-social-network social influence scores, factors, or data items is weighted by a corresponding social networking system weight. When the social influence score is based on data from multiple social networking systems, the score may be calculated as a weighted average of data from each of the social networking systems. The weighted average of social networking system data may be calculated by weighting each of the social influence factors by a corresponding social networking system weight. The social influence function that calculates the social influence score for a particular time t may be a function f of one or more of the social influence factors:

Social Influence Score(t)=f(FP(t), CP(t), CI(t), CQ(t)).

The social influence function (f) may be a weighted average function, in which case the social influence score at a particular time may be calculated as:

Social Influence Score (t)=(W_{Fp}*FP)+(W_{CP}*CP)+(W_{CI}*CI)+(W_{CQ}*CQ).

The social influence factor weights W_{FP}, WC_{P}, W_{CI}, and W_{CQ} correspond to the fan popularity, content publishing, content interaction, and content quality social influence factors, respectively, and may be floating-point values that add up to 1.0, The four factors may be equally weighted, e.g., each weight may be equal to 0.25. Alternatively, the weights may be calculated through analysis, and may vary. For example, different weights may be assigned to different factors based on the popularity of particular users (e.g., particular public figures). As another example, different weights may be used for fan-to-fan interactions than for fan-to-public figure interactions. That is, the Content Interaction (CI) factor may be split into two factors, such as a fan-to-fan content interaction factor and a fan-to-public figure content interaction factor, and the two factors may have different weights.

In particular embodiments, each of the factors FP, CP, CI, and CQ may be a weighted average of values calculated for each of the social-networking systems. For example, Fan popularity (FP) values may be calculated for the FB, TW, IG, and SC social-networking systems, and designated FP_{FB}, FP_{TW}, FP_{IG}, and FP_{SC}, respectively. The overall fan popularity value FP may be a weighted average of these per-social-networking system values in which the weights are referred to as per-social-networking system weights (to distinguish them from the social influence factor weights described above). For the FB social-networking system, the value of the fan popularity factor FP_{FB} for a user may be calculated based on the number of users of the social-networking system who follow the user. In one example, FP_{FB} for a user on the FB social-networking system may be calculated as the percentile out of all users on the FB system. For example, a user having FP_{FB}=0.75 may be ranked 225th among 1000 public figures on the FB social-networking system. The per-social-networking system weights for the overall fan popularity calculation may be designated W_{FB}, W_{TW}, W_{IG}, and W_{SC}, respectively, and the overall fan popularity value FP for the four example social-networking systems may be calculated as:

FP=(W_{FB}*FP_{FB})+(W_{TW}*FP_{TW})+(W_{IG}*FP_{IG})+(W_{SC}*FP_{SC}).

As an example, the value of a per-social-networking system weight, such as W_{FB}, may be based on the total number of verified users of the system divided by the total number of verified users of all systems in the ecosystem (e.g., FB, TW, IG, and SC). The other system weights (W_{TW}, W_{IG}, and W_{SG}) may be calculated similarly. Further, the other social-influence factors, CP, CI, and CQ, may each be averages of multiple per-social-networking system factors. The per-social networking system weights W_{FB}, W_{TW}, W_{IG}, and W_{SC} may be used to calculate the CP, CI, and CQ values as weighted averages of the per-social-networking system factors. Alternatively, the per-social networking system weights may be different for different social influence factors, as described below.

The social influence factor weights and the per-social networking system weights may be determined by analyzing data related to activities of users or desired results on one or more social networks and/or data related to activities or desired results external to the social-networking systems, such as actions in the real world, e.g., event attendance, advertising or sales revenue, election results, and so on. Such data items that are related to activities and numerically quantify desired results are referred to herein as “success factors.”

In particular embodiments, a social influence algorithm may be generated by identifying values of the social influence factors that are correlated to increases or decreases in success factor values and adjusting the algorithm to produce corresponding respective increases or decreases in the social influence factors or score. For example, if at least a threshold positive change of one of the success factors occurs soon after a change in one of the social influence factors, then that social influence factor may be weighted highly in a social influence function or algorithm to be used when high values of that success factor are desired. As another example, the algorithm may use a mapping that produces output social influence scores that are similar to, or have trends similar to, the values or trends of the success factors for similar input values. The input values to the social influence scoring algorithm may be one or more of the social influence factors. The mapping for the scoring algorithm may alternatively be generated using curve fitting techniques based on the success factors to generate a function that maps the input values to social influence scores having values or trends correlated to those of the success factors for similar input values. The social influence algorithm may subsequently be used to calculate a social influence score that can determine whether the user's subsequent actions on the social networking system(s) are likely to result in the desired values of the success factors, without actually measuring subsequent values of the success factors. This technique may be used when, for example, automated measurement of the success factors to evaluate the user's actions is not practical.

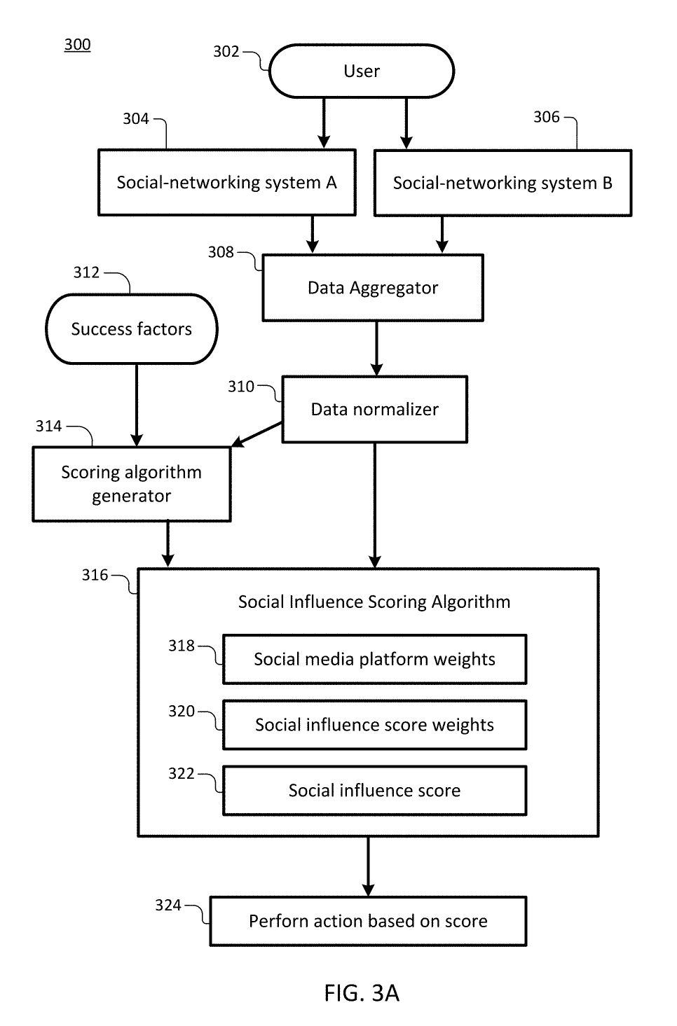

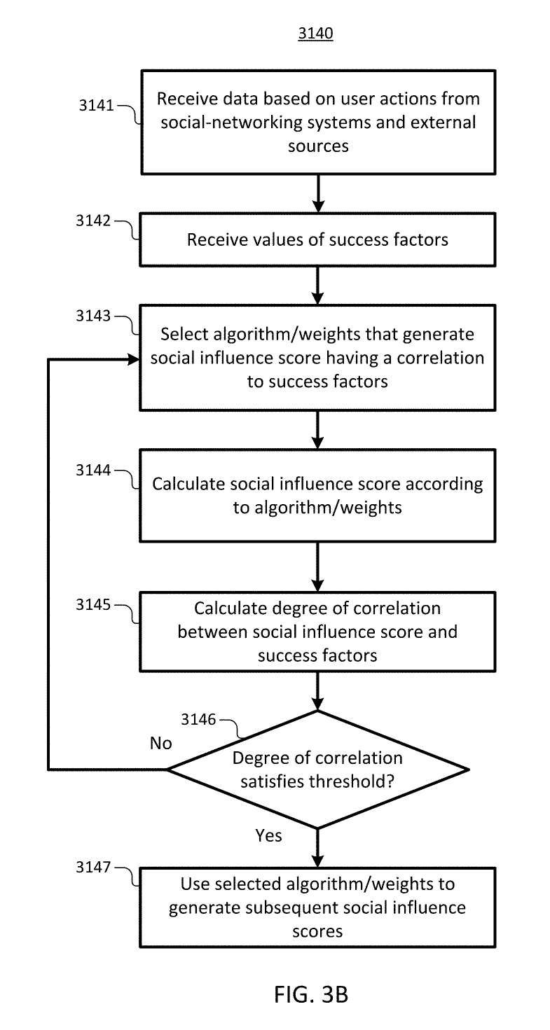

FIG. 3A illustrates an example embodiment of a system 300 for quantifying social influence and performing actions based on the social influence. The system 300 includes two social-networking systems, referred to as social-networking system A 304 and social-networking system B 306. System A 304 may provide an online social network. System B may provide another online social network, e.g., a photo sharing online social network. The system 300 may be implemented by one or more computer systems, such as servers 162 that communicate with the social-networking systems 304, 306. A user 302 may be a user of both social-networking systems A 304 and B 306, e.g., a user having separate login accounts on the two systems 304, 306. Alternatively, the user 302 may have a single login account that provides access to both systems.

In particular embodiments, a data aggregator 308 receives social network data from the systems 304, 306 and aggregates the social network data into a form suitable for input to a data normalizer 310. The social network data may represent activities associated with the user on the social-networking systems. The activities may include sending messages such as status updates, posts comments, tweets, and so on. The data may be a stream of activity objects, which may be received via a network connection from a server. Each activity object may include or be associated with metadata, such as a time stamp that indicates when the activity occurred, type information indicating the type of the activity, and user information identifying a user who created the activity and one or more users to whom the activity is directed.

In particular embodiments, in a data ingestion step, which may be part of the data aggregator 308, the social network data may be retrieved from social-networking systems such as

FB, TW, IG, SC, and others using public application-programming interfaces (APIs). The data may be received from data sources such as raw data feeds provided by social-networking systems (e.g., from a social-networking system server via a social-networking system API) or from aggregated data feeds provided by data aggregators (e.g., from a data aggregator server via a data aggregator API). The data may be received in different formats, e.g., short messages, text messages, chat messages, photo-sharing network posts, comments, photos, videos, text, links and so on, and may be parsed and normalized. The data may near-real-time data, which may be received soon after the corresponding social-networking system activities represented by the data occur, or may be historical data that represents activities that occurred in the past, e.g., within a specified time period. The data may be received from the data aggregator via an Internet connection to a server hosted by the data aggregator. The data may be in JSON/XML format, for example.

In particular embodiments, some users may have accounts on multiple social-networking systems, and others on a single social-networking system. A user may have different followers on different social-networking systems. A user's followers may be identified as either the union or intersection of the followers on all the social-networking systems. In the examples herein, a user's followers are the union of their followers on the four social-networking systems in the ecosystem. Data may be aggregated at a daily level, aggregated for each geographic location, and/or aggregated for each vertical. A social influence score representing the social influence of a user on one or more social-networking systems may be calculated or updated based on the aggregated data. The score may be based on frequency of activity by the user, e.g., daily or weekly. The social influence scores of users who have less frequent activity (e.g., provide weekly content updates) may be reduced relative to those who have more frequent activity (e.g., daily updates). Alternatively, instead of a reduction for less frequent activity, a daily, weekly, and/or monthly average may be calculated and used as part of the score.

A data normalizer 310 may normalize the aggregated data to form normalized data. The data is normalized to handle differences between different social-networking systems. The normalizer 310 may normalize the different social-networking system-specific types of content into normalized content. Normalized content from different social-networking systems may be compared. A normalized version of a post from one type of social-networking system may be compared to a normalized version of a post (or the closest analog of a post) from a different type of social-networking system. Videos and photos may also be transformed or converted into a normalized format. Properties that are common to different types of content are represented in the normalized content. Normalized properties may include, for example, an industry vertical property, which may be a category, e.g., musicians, athletes, actors, comedians, comedian, actor, entertainers. Other normalized properties may include geography, e.g., city or region (e.g., Asia-Pacific), language, and other demographic properties. If a property is not present in the input, e.g., is unknown, then a predicted or default value may be used. The data aggregator 308 and normalizer 310 may be executed at periodic time intervals, e.g., daily, weekly, or other time interval.

In particular embodiments, a social influence scoring algorithm 316 may calculate a social influence score 322 based on the social network data. As an example, four social-networking systems (FB, TW, IG, and SC) may be tracked. In this example, for each social-networking system, four social influence factors may be calculated. The social influence factors may include fan popularity, content publishing, content interaction, and content quality. A social influence score 322 may be calculated for a particular user based on the aggregated data upon request, e.g., when the social networking system requests scores for a set of users, or when a particular user requests their own score. That is, the aggregator 308 and normalizer 310 may be executed at times independent of when the social influence scoring algorithm 316 is executed, and the social influence scoring algorithm may be executed independently of the data aggregator 308 and normalizer 310 (although the aggregator 308 and normalizer 310 should be executed at least once prior to the social influence scoring algorithm 316 to prepare data for the algorithm 316). Although the data aggregator 308 and data normalizer 310 are shown as separate components, they are each optional, and one or both of them may be part of a different component, or they may be combined into a single component.

In particular embodiments, the social influence factors, including Fan Popularity, Content Publishing, Content Interaction, and Content Quality may similarly be based on weighted averages of data values from multiple social-networking systems. For Content Quality, policy guidelines may be used to identify high quality content and low quality content. Weights may be assigned to the social networking systems. The weights may be equal, or may be different for different social-networking systems. For example, content on one social-networking system may be weighted higher than content on another social-networking system, e.g., because there are more users on the first social-networking system. As another example, the per-social-networking system weight for a particular system may be calculated based on the total number of verified public figures on the system divided by the total number of verified public figures in the ecosystem (e.g., the sum for all social-networking systems being measured).

In particular embodiments, the social influence scoring algorithm 316 may be implemented as a function (e.g., of time) or a sequence of steps that calculates the social influence score 322. The score 322 may be calculated based on a combination of social influence factors. The social influence factors may be calculated based on the normalized data and combined to form a single social influence score 322. The social influence scoring algorithm 316 may use social-networking system weights 318 to weight social network data from different social-networking systems differently, and using social influence score weights 320 to weight different social influence factors differently in the calculation of the social influence score 322.

In particular embodiments, a scoring algorithm generator 314 may generate or modify the social influence scoring algorithm 316. The scoring algorithm generator 314 may use success factors 312 to evaluate the results of the social influence scoring algorithm 316 and change the algorithm so that the algorithm's output more closely correlates to the success factors 312, e.g., by changing weights in a linear scoring function or changing coefficients in a polynomial scoring function.

In particular embodiments, the social influence function may be a polynomial function of one or more of the social influence factors, or other type of function. The function may be determined using a curve-fitting technique to find a function that maps historical values of social influence factors to historical social influence scores (e.g., training data). A curve-fitting technique may alternatively be used to find a function that maps social influence factors to success factors that measure quantities representing desired effects of social influence, such as a number of followers, a number of votes in an election, a number of items sold and so on. The desired effects of social influence may be different for different users, depending on the particular user's desired effects of the social influence score. A function that maps social influence factors to success factors may be used as the basis for a function that maps social influence factors to a social influence score, because increasing values of success factors correspond to increasing values of the social influence score. The function may then be modified as appropriate to map the success factors to the social influence score.

In particular embodiments, the social influence scores may be re-calculated repeatedly over time and recorded for later analysis. Each recorded score may be associated with a time interval for which the score is calculated. For example, on Jan. 1, 2014, a score is calculated for each social network user. Suppose that a user's score is 0.85. The score is recorded as: Jan 1-Feb 1: ID=923451 Score=0.85. Subsequent scores can be stored in the same way, or can be stored as deltas to the previous score. For example, a score calculated on February 2 may be stored as: Feb 2: delta=+0.5. The scores can be trended over time. A decay can be applied, so that scores are reduced exponentially based on their age. A snapshot may be taken of the past scores to determine whether a user's score is trending up or down. For publicly-available data, comparisons between different users in the same category (e.g., industry vertical or geography) can be shown, such as the top five most influential users or public figures in an industry vertical.

In particular embodiments, an application component 324 may perform one or more actions based on the social influence score 322. The actions may include or be related to tasks such as (1) acquiring more public figures and causing a public figure to be more engaged on social-networking systems, (2) retaining public figures by helping them engage more with their audiences, and (3) monetization, e.g., identifying how the public figures and social-networking systems can increase monetization with social interactions. For example, the action performed by application 324 may include identifying one or more of the social influence factors that are associated with a subset of the user's audience, e.g., teenagers or other demographic group, or musicians or other users having a particular interest, and targeting advertisements to the subset when each of the social influence factors satisfies a corresponding threshold condition.

FIG. 3B illustrates an example method 3140 for generating social influence scoring algorithms. The method 3140 may implement the scoring algorithm generator 314 of FIG. 3A, and may be performed by a computer system. The method may begin at step 3141 by receiving data from one or more social networking systems 304, 306 and/or one or more other external data sources such as third-party systems 170. At step 3142, the method may receive or determine values of one or more success factors, such as those shown in FIG. 5. At step 3143, the method may select an algorithm to generate a social influence score that is correlated to the success factors. The algorithm may be implemented as a function, such as a weighted linear or polynomial function, in which case the method may select a particular function and weights for the function at step 3143. At step 3144, the method may calculate a social influence score according to the algorithm or weights selected at step 3143. At step 3145, the method may calculate a degree of correlation between the social influence score calculated at step 3144 (or one or more individual social influence factors) and the success factor values determined at 3142. The degree of correlation may be calculated by, for example, a sum of squares of the differences between the social influence score and the success factors at multiple points in time. As another example, if the social influence score (or the individual social influence factors) are not directly comparable to the success factors, then upward or downward trends in the social influence score (or factors) may be compared to trends in the success factors to identify correlations.

At step 3146, the method may determine whether the degree of correlation satisfies a threshold condition, e.g., whether the degree of correlation is less than a threshold value, whether the success factor trends are in the same direction as and occur close in time to the social influence score trends, whether changes in the social influence score are similar in magnitude to changes in the success factor, or the like. For example, if the social influence score or a particular social influence factor being evaluated increases (or decreases) between two points in time, e.g., between 1 Jan. 2016 and 3 Jan. 2016, and the success factor changes in the same direction, e.g., increases (or decreases) between the same two points in time, then there may be a correlation between the social influence score (or social influence factor being evaluated) and the success factor for at least that time period. If such a correlation occurs for a threshold period of time, e.g., 5 days, 1 week, 1 month, or the like, or for multiple time periods, e.g., 3, 10, or 20 consecutive or non-consecutive time periods, or a duration of time periods corresponding to the threshold period of time, then the degree of correlation satisfies the threshold. Otherwise, if the social influence score changes in a different direction from the success factor in a particular time period, then the score and the factor may be uncorrelated.

As another example, if the social influence score changes in the same direction as the success factor, but with more than a threshold magnitude (e.g., by more than a multiple of a value such as 1.5, 2.0, 2.5, or the like), then the social influence score and the success factor may be uncorrelated. Further, the correlation may be greater when the social influence score changes in the same direction as the success factor for a number of consecutive time periods than for the same number of time periods in which at least two of the time periods are not consecutive.

In particular embodiments, if the degree of correlation satisfies the threshold condition, then step 3147 uses the selected algorithm or weights to generate subsequent social influence scores. Otherwise, if the threshold condition is not satisfied, step 3143 may be executed again to select another algorithm, modify the selected algorithm, modify the selected weights, or the like. At step 3147, the method may use the selected algorithm or weights to generate subsequent social influence scores without further reference to the success factors.

Particular embodiments may repeat one or more steps of the method of FIG. 3B, where appropriate. Although this disclosure describes and illustrates particular steps of the method of FIG. 3B as occurring in a particular order, this disclosure contemplates any suitable steps of the method of FIG. 3B occurring in any suitable order. Moreover, although this disclosure describes and illustrates an example method for generating social influence scoring algorithms including the particular steps of the method of FIG. 3B, this disclosure contemplates any suitable method for generating social influence scoring algorithms including any suitable steps, which may include all, some, or none of the steps of the method of FIG. 3B, where appropriate. Furthermore, although this disclosure describes and illustrates particular components, devices, or systems carrying out particular steps of the method of FIG. 3B, this disclosure contemplates any suitable combination of any suitable components, devices, or systems carrying out any suitable steps of the method of FIG. 3B.

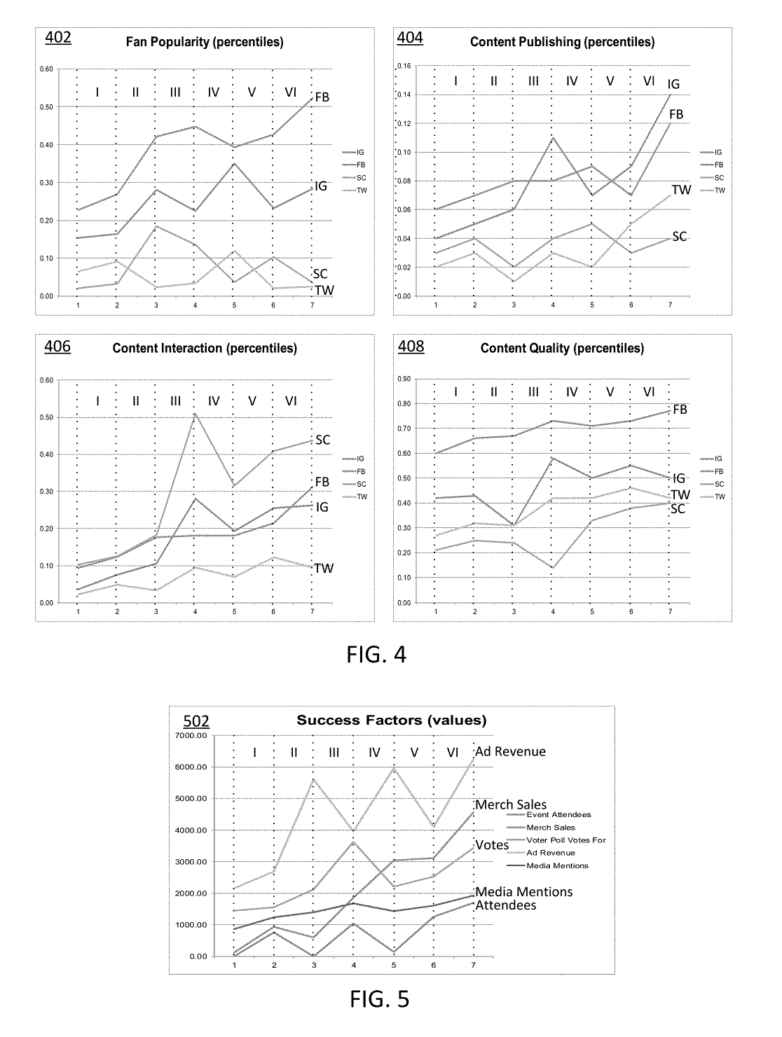

FIG. 4 illustrates example social influence factor values. In particular embodiments, social influence factors are components of the social influence score. Four social influence factors are shown in FIG. 4, with one social influence factor being shown in each of four graphs 402-408. A fan popularity graph 402 shows the values of the weighted components of the fan popularity social influence factor. The fan popularity social influence factor is calculated in this example as follows. Fan popularity data for a specified user over a period of time is received from four social-networking systems 180, which are referred to as FB, IG, SC, and TW. The fan popularity data includes follower counts for seven successive days (1 Jan. 2016 through 7 Jan. 2016). Each follower count is a count of the number of followers of the user for a time period of one day. Example follower counts are shown in TABLE 1 below. A follower count may be, for example, the number of followers of the user at a particular time on the day, e.g., at 9:00 am, or at the beginning or end of the day, or, alternatively, an average number of followers for one day. The follower count may alternatively be an average of the number of followers at different times during the day, e.g., an average of the follower counts measured at intervals during the day, such as every hour. Although the time period for each data item is one day in this example, other time periods may be used instead, e.g., one hour, 12 hours, two days, one week, and so on. These variations may apply to any social influence factor. Seven time periods are used in the example, but any number of time periods may be used in other examples. Further, although four particular social networking systems are used in this example, any number of systems and other systems may be used as the sources of data for the social influence factors and scores.

TABLE 1

| Fan | (# fans) | | | | | WeightSame | WeightUsers |
|---|---|---|---|---|---|---|---|
| Popularity | IG | FB | SC | TW | Total | Average | Average |
| 1 Jan. 2016 | 764.00 | 1138.00 | 101.00 | 327.00 | 2330.00 | 582.50 | 920.49 |
| 2 Jan. 2016 | 821.00 | 1341.00 | 162.00 | 461.00 | 2785.00 | 696.25 | 1083.35 |
| 3 Jan. 2016 | 1405.00 | 2101.00 | 922.00 | 115.00 | 4543.00 | 1135.75 | 1135.75 |
| 4 Jan. 2016 | 1121.00 | 2235.00 | 677.00 | 168.00 | 4201.00 | 1050.25 | 1710.10 |
| 5 Jan. 2016 | 1751.00 | 1961.00 | 181.00 | 601.00 | 4494.00 | 1123.50 | 1663.07 |
| 6 Jan. 2016 | 1160.00 | 2137.00 | 517.00 | 105.00 | 3919.00 | 979.75 | 1635.94 |
| 7 Jan. 2016 | 1421.00 | 2617.00 | 180.00 | 123.00 | 4341.00 | 1085.25 | 1979.37 |

In TABLE 1, the WeightSame column contains an average of the fan popularity values (e.g., follower counts) of the four systems in which each value is weighted equally. The WeightUsers column contains an average of the fan popularity values in which each value is weighted according to the size of the corresponding system's user base. These averages may be used when calculating the social influence score. However, to simplify comparisons between and combination of the different social influence factors, normalized averages based on these averages are used in the calculations described herein. The normalized averages are described in further detail below.

In the example shown in TABLE 1, the follower counts may be in thousands, so, for example, the count of 764 followers on 1 Jan. 2016 for the IG system may be interpreted as 764,000 followers. Other scales may be used, and the fan popularity factor may be measured in units other than follower counts. For example, the fan popularity factor may instead or in addition be based on the number of times the user gains a new follower (a positive contribution) or loses an existing follower (a negative contribution) in a particular time period. The fan popularity data may be normalized to the range 0.0-1.0 by dividing each follower count by an upper limit value, such as the greatest number of followers of any user on each of the social-networking systems 160, or a target goal number of followers determined by the user. The follower counts may be converted to percentiles. For example, the count value 764 for the IG system 160 may correspond to a percentile such as 0.15 (where 0.0 is a minimum percentile and 1.0 is a maximum percentile). In this example, the fan popularity data is normalized by dividing the counts from the each social-networking system 160 by the upper limit value 5000. The resulting fan popularity factors (referred to herein as “percentiles”) are shown in TABLE 2 below.

TABLE 2

| Fan | (% tiles) | | | | | WeightSame | WeightUsers |
|---|---|---|---|---|---|---|---|
| Popularity | IG | FB | SC | TW | Total | Average | Average |
| 1 Jan. 2016 | 0.15 | 0.23 | 0.02 | 0.07 | 0.47 | 0.12 | 0.18 |
| 2 Jan. 2016 | 0.16 | 0.27 | 0.03 | 0.09 | 0.56 | 0.14 | 0.22 |
| 3 Jan. 2016 | 0.28 | 0.42 | 0.18 | 0.02 | 0.91 | 0.23 | 0.33 |
| 4 Jan. 2016 | 0.22 | 0.45 | 0.14 | 0.03 | 0.84 | 0.21 | 0.34 |
| 5 Jan. 2016 | 0.35 | 0.39 | 0.04 | 0.12 | 0.90 | 0.22 | 0.33 |
| 6 Jan. 2016 | 0.23 | 0.43 | 0.10 | 0.02 | 0.78 | 0.20 | 0.33 |
| 7 Jan. 2016 | 0.28 | 0.52 | 0.04 | 0.02 | 0.87 | 0.22 | 0.40 |

TABLE 2 shows that the fan popularity percentiles for the IG system on 1 Jan. 2016 in this example is 0.15, which is the number of followers (764) divided by the upper limit of 5000 followers. Two weighted averages are shown in TABLE 2: a “WeightSame” average in which the four systems are equally-weighted, with a weight of 0.25 each, and a “WeightUsers” average in which the four systems are weighted in proportion to the sizes of their user bases. For the fan popularity averages in which the four systems are equally-weighted, the WeightSame column indicates that the average fan popularity for the four systems is 0.12 on 1 Jan. 2016, 0.14 on 2 Jan. 2016, and so on. For the fan popularity averages in which the four systems are weighted in proportion to how many users they have, the WeightUsers column indicates that the average fan popularity is 0.18 on 1 Jan. 2016, 0.22 on 2 Jan. 2016, and so on. The larger values in this case are the result of the FB system having higher-than-average values that are given more weight. In this example, the number of users of each system is as follows: 400 million for IG, 1591 million for FB, 125 million for SC, and 305 million for TW. The weights are therefore W_{IG}=0.17, W_{FB}=0.66, W_{SC}=0.13, and W_{TW}=0.13. The number of users may be the total number of users of each system, the number of active users of each system, or other subset of the total number of users of each system, e.g., the users who live in a particular country or are in a particular age range. Other values of the weights may be used, based on the number of users or on other factors, e.g., based on the number of public figures who are users of each system, or the like. The weights may change over time as the number of users or other quantities on which the weights are based change.

Referencing FIG. 4, a content publishing graph 404 shows the values of the weighted components of the content publishing social influence factor. The content publishing social influence factor may be based on the number of content items published or otherwise made available by the user on one or more social-networking systems 160. The content publishing factor is calculated in this example as follows. Content publishing data for a specified user over a period of time is received from the four social-networking systems 180. The content publishing data includes counts of how many content items, e.g., posts and other content, the user has published on the social networking systems 160 for seven successive days (1 Jan. 2016 through 7 Jan. 2016). Each published item count may be a count of the number of posts, replies, and/or comments the user made on one day. Example post counts are shown in TABLE 3 below. The published item count may be, for example, the total number of posts made by the user on the corresponding day, or the total number of posts made by the user since the user joined the social networking system 160. The published item counts may alternatively be averages, and may be for multiple time periods during each day.

TABLE 3

| Content Pub. | (Items) | | | | | WeightSame | WeightUsers |
|---|---|---|---|---|---|---|---|
| Day | IG | FB | SC | TW | Total | Average | Average |
| 1 Jan. 2016 | 4.00 | 6.00 | 3.00 | 2.00 | 15.00 | 3.75 | 5.01 |
| 2 Jan. 2016 | 5.00 | 7.00 | 4.00 | 3.00 | 19.00 | 4.75 | 6.01 |
| 3 Jan. 2016 | 6.00 | 8.00 | 2.00 | 1.00 | 17.00 | 4.25 | 6.48 |
| 4 Jan. 2016 | 11.00 | 8.00 | 4.00 | 3.00 | 26.00 | 6.50 | 7.66 |
| 5 Jan. 2016 | 7.00 | 9.00 | 5.00 | 2.00 | 23.00 | 5.75 | 7.58 |
| 6 Jan. 2016 | 9.00 | 7.00 | 3.00 | 5.00 | 24.00 | 6.00 | 6.87 |
| 7 Jan. 2016 | 14.00 | 12.00 | 4.00 | 7.00 | 37.00 | 9.25 | 11.29 |

In particular embodiments, the content publishing factor may be measured in units other than posts, replies, and comments. For example, the content publishing factor may instead or in addition be based on the number of words or characters in posts or other content published by the user. The term “posts” is used herein to refer to any content item that may be made available by the user to other users, such as text, images, video, audio, and the like. For social networking systems that refer to user-published content by different names, e.g., messages or other terms, or have different publishing models, the analogous items of user-published content may be substituted for posts, replies, and comments. The content publishing data may be normalized to the range 0.0-1.0 by dividing each content publishing value by an upper limit goal value, such as the greatest number of published items of any user on each of the social-networking systems 160, or a target number of published items determined by the user. The counts of published items may be converted to percentiles, so that, for example, the published item count 4.0 for the IG system 160 may correspond to a percentile such as 0.04. In this example, the content publishing data is normalized by dividing the counts from the each social-networking system 160 by an upper limit or goal value 100. The resulting content publishing factors (referred to herein as “percentiles”) are shown in TABLE 4 below.

TABLE 4

| | (% tiles) | | | | | WeightedSame | WeightsFromUsers |
|---|---|---|---|---|---|---|---|
| Content Pub. | IG | FB | SC | TW | Total | Average | Average |
| 1 Jan. 2016 | 0.04 | 0.06 | 0.03 | 0.02 | 0.15 | 0.04 | 0.05 |
| 2 Jan. 2016 | 0.05 | 0.07 | 0.04 | 0.03 | 0.19 | 0.05 | 0.06 |
| 3 Jan. 2016 | 0.06 | 0.08 | 0.02 | 0.01 | 0.17 | 0.04 | 0.06 |
| 4 Jan. 2016 | 0.11 | 0.08 | 0.04 | 0.03 | 0.26 | 0.07 | 0.08 |
| 5 Jan. 2016 | 0.07 | 0.09 | 0.05 | 0.02 | 0.23 | 0.06 | 0.08 |
| 6 Jan. 2016 | 0.09 | 0.07 | 0.03 | 0.05 | 0.24 | 0.06 | 0.07 |
| 7 Jan. 2016 | 0.14 | 0.12 | 0.04 | 0.07 | 0.37 | 0.09 | 0.11 |

TABLE 4 shows that the content publishing percentile for the IG system on 1 Jan. 2016 in this example is 0.04, which is the number of posted content items (4.0) divided by the upper limit of 100 content items. The weighted averages are similarly divided by the upper limit 100.

A content interaction graph 406 shows the values of the weighted components of the content interaction social influence factor, which may be the count of content items published by the user (e.g., as determined for the content publishing factor) plus the count of items published by other users and addressed to the user. The content interaction social influence factor is calculated in this example as follows. Content interaction data for a specified user over a period of time is received from the four social-networking systems 180. The content interaction data includes counts of how many content items, e.g., posts and other content items, the user has published or other users have published addressing the user on the social networking systems 160 for seven successive days (1 Jan. 2016 through 7 Jan. 2016). Each published item count many be a count of the number of posts, replies, and/or comments the user made and the number of posts, replies, and/or comments that other users have made directed to the user on one day. Example post counts are shown in TABLE 5 below. The published item count may be, for example, in addition to the total number of posts made by the user on the corresponding day, the total number of posts, comments, or replies made by other users that are addressed to the user (e.g., posts by other users on the user's timeline or activity stream, or comments or replies by other users on or to the user's posts, replies, or comments).

TABLE 5

| Content Int. | (Items) | | | | | WeightSame | WeightUsers |
|---|---|---|---|---|---|---|---|
| Day | IG | FB | SC | TW | Total | Average | Average |
| 1 Jan. 2016 | 368.00 | 933.00 | 102.00 | 221.00 | 1624.00 | 406.00 | 707.05 |
| 2 Jan. 2016 | 759.00 | 1236.00 | 125.00 | 487.00 | 2607.00 | 651.75 | 1005.47 |
| 3 Jan. 2016 | 1052.00 | 1771.00 | 182.00 | 327.00 | 3332.00 | 833.00 | 1388.25 |
| 4 Jan. 2016 | 2805.00 | 1805.00 | 510.00 | 947.00 | 6067.00 | 1516.75 | 1795.27 |
| 5 Jan. 2016 | 1932.00 | 1812.00 | 315.00 | 688.00 | 4747.00 | 1186.75 | 1612.93 |
| 6 Jan. 2016 | 2551.00 | 2141.00 | 409.00 | 1224.00 | 6325.00 | 1581.25 | 2003.79 |
| 7 Jan. 2016 | 2623.00 | 3117.00 | 437.00 | 946.00 | 7123.00 | 1780.75 | 2623.50 |

Similarly to the content publishing factor, the counts of published items may be converted to percentiles. The resulting content publishing factors (referred to herein as “percentiles”) are shown in TABLE 6 below.

TABLE 6

| Content Int. | (% tiles) | | | | | WeightSame | WeightUsers |
|---|---|---|---|---|---|---|---|
| Day | IG | FB | SC | TW | Total | Average | Average |
| 1 Jan. 2016 | 0.04 | 0.09 | 0.10 | 0.02 | 0.25 | 0.06 | 0.08 |
| 2 Jan. 2016 | 0.08 | 0.12 | 0.13 | 0.05 | 0.37 | 0.09 | 0.11 |
| 3 Jan. 2016 | 0.11 | 0.18 | 0.18 | 0.03 | 0.50 | 0.12 | 0.15 |
| 4 Jan. 2016 | 0.28 | 0.18 | 0.51 | 0.09 | 1.07 | 0.27 | 0.20 |
| 5 Jan. 2016 | 0.19 | 0.18 | 0.32 | 0.07 | 0.76 | 0.19 | 0.18 |
| 6 Jan. 2016 | 0.26 | 0.21 | 0.41 | 0.12 | 1.00 | 0.25 | 0.22 |
| 7 Jan. 2016 | 0.26 | 0.31 | 0.44 | 0.09 | 1.11 | 0.28 | 0.28 |

TABLE 6 shows that the content interaction percentile for the FB system in this example is 0.09, which is the number of posted content items in the interactions (933) divided by the upper limit of 10000 content items.

Referencing FIG. 4, a content quality graph 408 shows the values of the weighted components of the content quality social influence factor, which may be a quantification of the quality of the user's posts or of other content published by the user. The content quality social influence factor is calculated in this example as follows. Content quality data for a specified user over a period of time is received from the four social-networking systems 180. The content quality data may include ratings of the quality of the content published by the user on a scale of 0 (lowest) to 10 (highest) on the social networking systems 160 for seven successive days (1 Jan. 2016 through 7 Jan. 2016). The ratings may be based on, for example, input from other users rating the user's published content. Although numeric quality ratings are used in this example, other measures of content quality may be used. The content quality factor may be based on a measure of authenticity of the content, on an automated analysis of the complexity level of the content, relevance of the content to related content items such as related posts, replies, or comments, or a combination thereof. Example quality ratings are shown in TABLE 7 below.

TABLE 7

Content Quality (ratings)

| | IG | FB | SC | TW |
|---|---|---|---|---|
| 1-Jan-16 | 4.20 | 6.00 | 2.10 | 2.70 |
| 2-Jan-16 | 4.30 | 6.60 | 2.50 | 3.20 |
| 3-Jan-16 | 3.10 | 6.70 | 2.40 | 3.10 |
| 4-Jan-16 | 5.80 | 7.30 | 1.40 | 4.20 |
| 5-Jan-16 | 5.00 | 7.10 | 3.30 | 4.20 |
| 6-Jan-16 | 5.50 | 7.30 | 3.80 | 4.60 |
| 7-Jan-16 | 5.00 | 7.70 | 4.00 | 4.20 |

The content quality ratings may be converted to percentiles for comparison or combination with other success factors. The resulting content quality factor percentiles are shown in TABLE 8 below.

TABLE 8

| Content Quality | (% tiles) | | | | | WeightSame | WeightUsers |
|---|---|---|---|---|---|---|---|
| Day | IG | FB | SC | TW | Average | Average | Average |
| 1 Jan. 2016 | 0.42 | 0.60 | 0.21 | 0.27 | 0.38 | 0.38 | 0.51 |
| 2 Jan. 2016 | 0.43 | 0.66 | 0.25 | 0.32 | 0.42 | 0.42 | 0.56 |
| 3 Jan. 2016 | 0.31 | 0.67 | 0.24 | 0.31 | 0.38 | 0.38 | 0.54 |
| 4 Jan. 2016 | 0.58 | 0.73 | 0.14 | 0.42 | 0.47 | 0.47 | 0.64 |
| 5 Jan. 2016 | 0.50 | 0.71 | 0.33 | 0.42 | 0.49 | 0.49 | 0.62 |
| 6 Jan. 2016 | 0.55 | 0.73 | 0.38 | 0.46 | 0.53 | 0.53 | 0.65 |
| 7 Jan. 2016 | 0.50 | 0.77 | 0.40 | 0.42 | 0.52 | 0.52 | 0.66 |

TABLE 8 shows that the content quality percentile for the FB system on 1 Jan. 2016 in this example is 0.60, which is the quality rating (6.0) divided by an upper limit, or goal, quality of 10.

FIG. 5 illustrates example success factors. A success factor graph 502 is shown below the graphs of FIG. 4 for comparison with the success factor trends shown in the graphs 402-408. The success factors may be used to refine social-influence scoring algorithms 316 as described below. The success factors shown in FIG. 5 include advertisement revenue (e.g., in dollars), merchandise sales (e.g., in dollars), number of votes (e.g., from a poll of people who may vote yes or no on a question), number of mentions in media (e.g., in social media and/or other media, such as television, radio, print, and so on), and an event attendee count (e.g., how many people attended one or more particular real-world or virtual events). The data values on which the success factor graph 502 is based are listed in TABLE 9 below.

TABLE 9

| | Success Factors | | | | |
|---|---|---|---|---|---|
| | | Merchan- | Voter | | |
| | Event | dising | Poll | Advertisement | Media |
| Date | Attendees | Sales | Votes | Revenue | Mentions |
| 1-Jan-16 | 0.00 | 124.00 | 1451.00 | 2157.00 | 854.00 |
| 2-Jan-16 | 752.00 | 921.00 | 1543.00 | 2685.00 | 1236.00 |
| 3-Jan-16 | 0.00 | 602.00 | 2112.00 | 5603.00 | 1390.00 |
| 4-Jan-16 | 1043.00 | 1843.00 | 3618.00 | 3963.00 | 1677.00 |
| 5-Jan-16 | 125.00 | 3043.00 | 2210.00 | 5965.00 | 1429.00 |
| 6-Jan-16 | 1243.00 | 3111.00 | 2523.00 | 4103.00 | 1599.00 |
| 7-Jan-16 | 1696.00 | 4556.00 | 3427.00 | 6234.00 | 1923.00 |

In particular embodiments, the success factors shown in FIG. 5 are measures of the success of a user's actions on the social-networking systems 160 such as publishing content and interacting with other users. The success factors may be understood as measures of the user's achievement of goals that may be at least partially external to the social-networking systems 160. Greater values of the success factors are more desirable than lesser values, and the success factors are influenced at least in part by the user's actions on the social-networking systems 160. Thus, the success factors may be used to evaluate the success of a user's actions on the social-networking systems 160 according to criteria deemed important by the user. Although particular success factors are disclosed herein, this disclosure contemplates other success factors appropriate for a user's goals.

In particular embodiments, a social influence score generated by an algorithm may be compared to the values of one or more success factors for the same time period to determine how closely the social influence score correlates to the success factors. If the generated social influence score correlates closely to the success factors, then the social influence scoring algorithm may be used, e.g., when the success factors are not known, to generate a social influence score that indicates how successful the user's actions are based on social influence factors instead of on success factors. Such an algorithm is useful because, e.g., obtaining success factor values may not be practical at the times for which the user's success is to be evaluated. Social influence scores may be more easily determined than success factors because the score are generated from data more readily available in the social-networking systems 160.

In particular embodiments, a social influence scoring algorithm may be generated by identifying one or more social influence factors, on one or more social-networking systems that are correlated with a success factor, and adjusting or increasing the weight of the social influence factors in the social influence score calculation so that the social influence factors and associated social-networking systems that produced scores correlated to the success factors are given more weight, and the social influence factors that produced scores uncorrelated to the success factors are given less weight. For example, each of the success factors shown in FIG. 5 may be correlated with at least one of the social influence factors in FIG. 4 for at least one of the four social-networking systems. The social influence factor, and associated social-networking system, that correlate with a particular success factor may be weighted higher than other social influence factors and associated social-networking systems when generating a social influence score for a user having a goal corresponding to that success factor.

For example, the advertisement revenue success factor shown in FIG. 5 is correlated with the fan popularity factor on the IG social-networking system shown in graph 402 as can be seen by the similarity in the trends (increasing and decreasing the same days) of the advertisement revenue success factor in FIG. 5 and the fan popularity factor on the IG social-networking system in graph 402. Thus, the fan popularity factor and the IG social-networking system should be heavily weighted in comparison to other factors and associated social-networking systems (e.g., weights of 0.7 or greater, 0.9 or greater, 1.0 (where the weight of 1.0 excludes the other factors and associated social-networking systems), or other value greater than 0.5) to generate a social influence score that is correlated with the advertisement revenue success factor. The remaining portion of the weight (e.g., 0.3) may be divided among the other social influence factors and social-networking systems (e.g., 0.1 for each of the three remaining factors and associated social-networking systems). As another example, the vote count success factor shown in FIG. 5 is correlated with the content publishing factor on the IG social-networking system shown in graph 404, as can be seen from the similarity of the shapes of the vote count and content publishing lines. Thus, the content publishing factor and the IG social-networking system should be heavily weighted in comparison to other factors and social-networking systems if generating a social influence score correlated with the vote count success factor is desired.

As yet another example, the event attendees success factor shown in FIG. 5 is correlated with the content interaction factor on the TW social-networking system shown in graph 406 and, to a lesser extent, is correlated with the content interaction factor on the SC social-networking system shown in graph 406. That is because, although the SC social-networking system's content interaction trends are similar to those of the event attendees success factor, the change in magnitude on day 4 compared to days 3 and 5 is substantially greater on the SC social-networking system than on the TW social-networking system for the event attendees success factor. Thus, to generate a social influence score that correlates with the event attendees success factor, the content interaction factor and the IG social-networking system should be heavily weighted (e.g., 0.7) in comparison to other factors and social-networking systems, and the content interaction factor and the SC social-networking system may be given a medium (e.g., 0.2) weight. The remaining weight (e.g., 0.1) may be divided among the other factors and social-networking systems, either evenly, or according to comparison with one or more success factors as described in the example above for the content interaction factor and the TW social-networking system, or according to other criteria.

As still another example, the media mentions success factor shown in FIG. 5 is correlated with the content quality factor on the FB social-networking system shown in graph 408, as can be seen by the similarity in the shapes of the media mentions and content quality lines. Thus, the content quality factor and the FB social-networking system should be heavily weighted in comparison to other factors and social-networking systems if generating a social influence score that correlates with the media mentions success factor is desired.

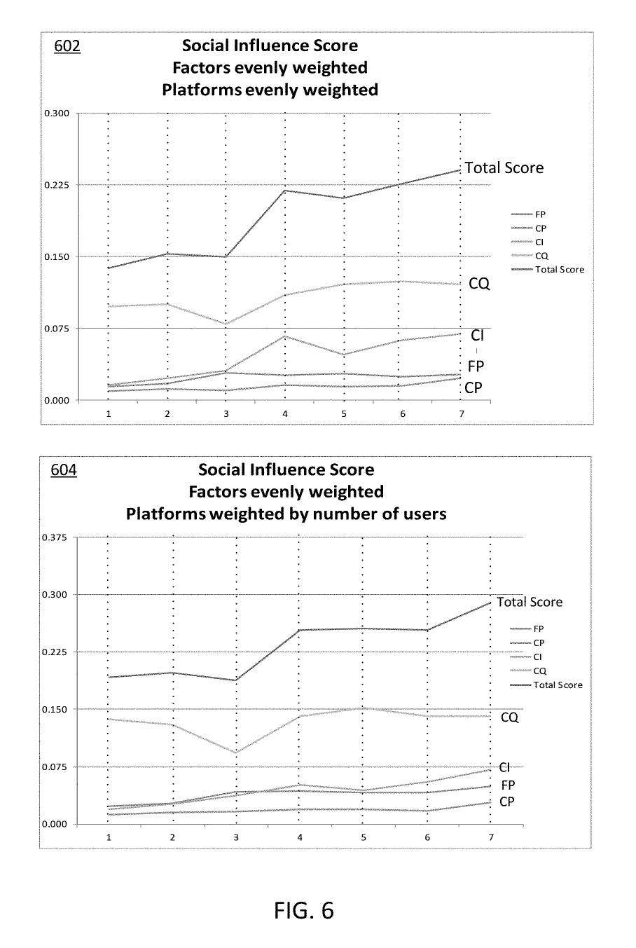

FIG. 6 illustrates example social influence scores for equally-weighted social influence factors. Social influence score graphs 602, 604 show values of the fan popularity (FP), content publishing (CP), content interaction (CI), and content quality (CQ) weighted social influence factors for each day in a 7-day period. In the graph 602, the data from each of four social-networking systems is weighted equally, whereas in the graph 604, the data from each of the four social-networking systems is weighted in proportion to the size of the corresponding social-networking system's user base when calculating the social influence factors. The social influence factors themselves are weighted equally when the social influence scores are calculated in both graphs 602 and 604. The graph 602 is based on TABLE 10 and the graph 604 is based on TABLE 11. TABLEs 10 and 11 list the values of the weighted social influence factors for seven successive days and the social influence score for each day. The sum of the weighted factors for each day is the social influence score for that day. TABLE 10 is based on social influence scores to which the four systems IG, FB, SC, and TW contribute equally. TABLE 11 is based on social influence scores to which the four systems contribute in proportion to the size of their respective user bases. The weighted factors in each of the FP, CP, CI, and CQ columns are determined by multiplying the weighted average values of the factor from the WeightSame (TABLE 10) or WeightUser (TABLE 11) column of the appropriate table above by the social influence factor weight for that column. In both TABLEs 10 and 11, the total score is an equally-weighted average of the social influence factors. The Total Score column, which represents the social influence score, is the sum of the four factor columns for each day. Other weightings are possible, however. For example, one of the social influence factors may be weighted by 0.7 and the other three factors may be weighted by 0.1.

TABLE 10 shows example social influence scores calculated from social-influence factors FP, CP, CI, and CQ that are equally-weighted averages of per-system social-influence factors received from each of the IG, FB, SC, and TW social-networking systems.

TABLE 10

Social Influence Score

| | FP | CP | CI | CQ | Total Score |
|---|---|---|---|---|---|
| 1-Jan-16 | 0.029 | 0.009 | 0.016 | 0.094 | 0.148 |
| 2-Jan-16 | 0.035 | 0.012 | 0.023 | 0.104 | 0.174 |
| 3-Jan-16 | 0.057 | 0.011 | 0.031 | 0.096 | 0.194 |
| 4-Jan-16 | 0.053 | 0.016 | 0.067 | 0.117 | 0.252 |
| 5-Jan-16 | 0.056 | 0.014 | 0.047 | 0.123 | 0.240 |
| 6-Jan-16 | 0.049 | 0.015 | 0.063 | 0.133 | 0.259 |
| 7-Jan-16 | 0.054 | 0.023 | 0.069 | 0.131 | 0.277 |

TABLE 11 shows example social influence scores calculated from social-influence factors FP, CP, CI, and CQ that are weighted averages of per-system social-influence factors received from each of the IG, FB, SC, and TW social-networking systems. The weighted averages in TABLE 10 are weighted according to the size of the user base (e.g., number of users) of each of the social-networking systems that contributes to the weighted averages.

TABLE 11

Social Influence Score

| | FP | CP | CI | CQ | Total Score |
|---|---|---|---|---|---|
| 1-Jan-16 | 0.046 | 0.013 | 0.019 | 0.127 | 0.205 |
| 2-Jan-16 | 0.054 | 0.015 | 0.027 | 0.139 | 0.235 |
| 3-Jan-16 | 0.084 | 0.016 | 0.037 | 0.136 | 0.273 |
| 4-Jan-16 | 0.086 | 0.019 | 0.051 | 0.159 | 0.314 |
| 5-Jan-16 | 0.083 | 0.019 | 0.044 | 0.155 | 0.301 |
| 6-Jan-16 | 0.082 | 0.017 | 0.055 | 0.162 | 0.316 |
| 7-Jan-16 | 0.099 | 0.028 | 0.071 | 0.166 | 0.363 |

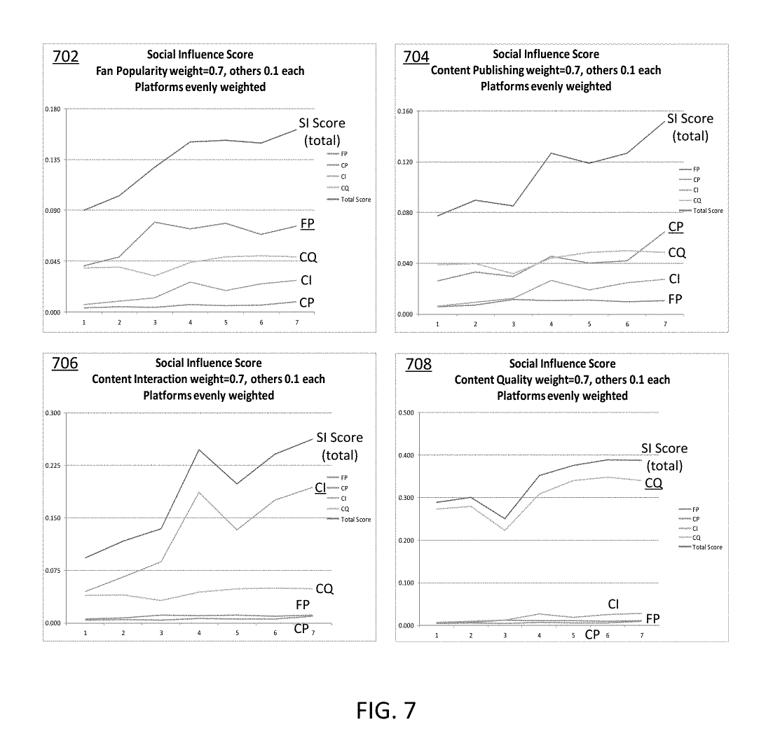

FIG. 7 illustrates example social influence scores for varying weightings of social influence factors with equally-weighted social networking systems. FIG. 7 shows how a social influence score's value over time may be shaped to resemble that of a selected social influence factor by increasing the weight of the selected social influence factor (e.g., to 0.7) and decreasing the weight of the other social influence factors (e.g., to 0.1 each). Since the other three factors in this example still have non-zero weights, the other three factors still determine a portion of the social influence score. FIG. 7 shows four social influence score graphs 702-708. In each of the graphs 702-708, a different social influence factor has a high weight (0.7 in this example), and the other three factors have low weights (0.1 each).

The graph 702 shows a social influence score calculated using a high weight (0.7) for the fan popularity factor (labeled FP) and low weights for the other three factors (0.1 each for the content publishing (CP), content interaction (CI), and content quality (CQ) factors). The social influence score (labeled SI Score) has a similar pattern to the highly-weighted fan popularity score FP, particularly during time periods when the other three factors remain relatively constant over time. The SI Score line resembles the highly-weighted FP line, but increases between days 3 and 6, whereas the FP line decreases on those days. The increasing values of the other three lines (CQ, CI, and CP) on days 3-6 cause the SI Score to increase more than the FP score during that time. The graph 702 is based on the factor and social influence score values shown in TABLE 12.

TABLE 12

Social Influence

| | FP | CP | CI | CQ | SI Score (total) |
|---|---|---|---|---|---|
| 1-Jan-16 | 0.082 | 0.004 | 0.006 | 0.038 | 0.129 |
| 2-Jan-16 | 0.097 | 0.005 | 0.009 | 0.042 | 0.153 |
| 3-Jan-16 | 0.159 | 0.004 | 0.012 | 0.038 | 0.214 |
| 4-Jan-16 | 0.147 | 0.007 | 0.027 | 0.047 | 0.227 |
| 5-Jan-16 | 0.157 | 0.006 | 0.019 | 0.049 | 0.231 |
| 6-Jan-16 | 0.137 | 0.006 | 0.025 | 0.053 | 0.221 |
| 7-Jan-16 | 0.152 | 0.009 | 0.028 | 0.052 | 0.241 |

The graph 704 shows a social influence score calculated using a high weight (0.7) for the content publishing factor (CP) and low weights for the other three factors (0.1 each for the fan popularity, content interaction, and content quality factors). The social influence score (SI) has a similar pattern to the highly-weighted content publishing score CP, particularly when the other three factors remain relatively constant or have a similar pattern to the CP score over time. The SI Score line resembles the highly-weighted CP line, but increases between days 1-2 and also between days 5-6, whereas the CP line remains nearly constant on those days. The increasing values of the CI and CQ lines cause the SI Score to increase more than the CP score during that time.

The graph 706 shows a social influence score calculated using a high weight (0.7) for the content interaction factor (CI) and low weights for the other three factors (0.1 each for the content publishing, fan popularity, and content quality factors). The social influence score (SI) has a similar pattern to the highly-weighted content interaction factor CI from days 1-7 because the other three factors remain relatively constant during that time.

The graph 708 shows a social influence score calculated using a high weight (0.7) for the content quality factor (CQ) and low weights for the other three factors (0.1 each for the content publishing, content interaction, and fan popularity factors). The social influence score (SI) has a similar pattern to the highly-weighted content quality factor CQ because the other three factors remain relatively constant over time. The SI Score line resembles the highly-weighted CQ line, but increases between days 6 and 7, whereas the CQ line decreases on those days. The increasing values of the CI and CQ lines on days 6-7 causes the SI Score to increase more than the CQ score during that time.

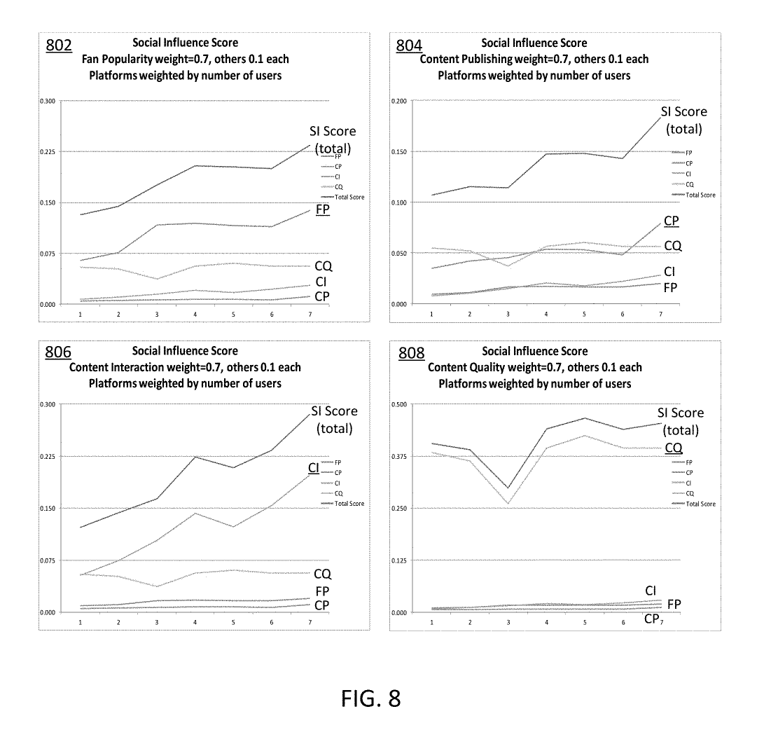

FIG. 8 illustrates example social influence scores for varying weightings of social influence factors, with social-networking systems being weighted by number of users. FIG. 8 shows how a social influence score's value may be shaped by four different weightings that each emphasize a different social influence factor. FIG. 8 shows four social influence score graphs 802-808. In each of the graphs 802-808, a different social influence factor has a high weight (0.7 in this example), and the other three factors have low weights (0.1 each). FIG. 8 is similar to FIG. 7, except that in FIG. 8 the weights of the social-networking systems are based on the size of the social-networking systems' user bases in the social influence factor calculations. In FIG. 7, the social-networking systems are equally weighted. In this example, the number of users of each system is as follows: 400 million for IG, 1591 million for FB, 125 million for SC, and 305 million for TW. The weights are therefore W_{IG}=0.17, W_{FB}=0.66, W_{SC}=0.13, and W_{TW}=0.13. Differences between FIG. 7 and FIG. 8 are the result of the FB system having greater weight (0.66) than the other systems (0.13-0.17) in FIG. 8. For example, the social influence scores in FIG. 8 are more similar to the values in FIG. 4, particularly for the highest-weighted factors in FIG. 8. The fan popularity factor in graph 802, content publishing factor in graph 804, content interaction factor in graph 806, and content quality factor in graph 808 are more similar to the corresponding factor values for the FB system in FIG. 4 than are the scores in FIG. 7 because of the higher weight (0.66) assigned to the FB system in FIG. 8.

The graph 802 shows a social influence score calculated using a high weight (0.7) for the fan popularity factor (labeled FP) and low weights for the other three factors (0.1 each for the content publishing (CP), content interaction (CI), and content quality (CQ) factors). The social influence score (labeled SI Score) has a similar pattern to the highly-weighted fan popularity score FP, particularly during time periods when the other three factors remain relatively constant over time. The SI Score line resembles the highly-weighted FP line, but increases between days 3 and 4, whereas the FP line is constant on those days. The increasing values of the CQ and CI factors between days 3 and 4 cause the SI Score to increase more than the FP score during that time. The graph 802 is based on the factor and social influence score values shown in TABLE 13.

TABLE 13

Social Influence

| | FP | CP | CI | CQ | SI Score (total) |
|---|---|---|---|---|---|
| 1-Jan-16 | 0.046 | 0.013 | 0.019 | 0.127 | 0.205 |
| 2-Jan-16 | 0.054 | 0.015 | 0.027 | 0.139 | 0.235 |
| 3-Jan-16 | 0.084 | 0.016 | 0.037 | 0.136 | 0.273 |
| 4-Jan-16 | 0.086 | 0.019 | 0.051 | 0.159 | 0.314 |
| 5-Jan-16 | 0.083 | 0.019 | 0.044 | 0.155 | 0.301 |
| 6-Jan-16 | 0.082 | 0.017 | 0.055 | 0.162 | 0.316 |
| 7-Jan-16 | 0.099 | 0.028 | 0.071 | 0.166 | 0.363 |

The graph 804 shows a social influence score calculated using a high weight (0.7) for the content publishing factor (CP) and low weights for the other three factors (0.1 each for the fan popularity, content interaction, and content quality factors). The social influence score (SI) has a similar pattern to the highly-weighted content publishing score CP, particularly when the other three factors remain relatively constant or have a similar pattern to the CP score over time. The SI Score line resembles the highly-weighted CP line, but is constant between days 2 and 3, whereas the CP line remains nearly constant on those days. The increasing values of the CQ, CI, and FP lines cause the SI Score to increase more than the CP score during that time.

The graph 806 shows a social influence score calculated using a high weight (0.7) for the content interaction factor (CI) and low weights for the other three factors (0.1 each for the content publishing, fan popularity, and content quality factors). The social influence score (SI) has a similar pattern to the highly-weighted content interaction factor CI from days 1-7 because the other three factors remain relatively constant during that time.

The graph 808 shows a social influence score calculated using a high weight (0.7) for the content quality factor (CQ) and low weights for the other three factors (0.1 each for the content publishing, content interaction, and fan popularity factors). The social influence score (SI) has a similar pattern to the highly-weighted content quality factor CQ because the other three factors remain relatively constant over time. The SI Score line resembles the highly-weighted CQ line, but increases between days 6 and 7, whereas the CQ line decreases on those days. The increasing values of the CI and CQ lines on days 6-7 causes the SI Score to increase more than the CQ score during that time.

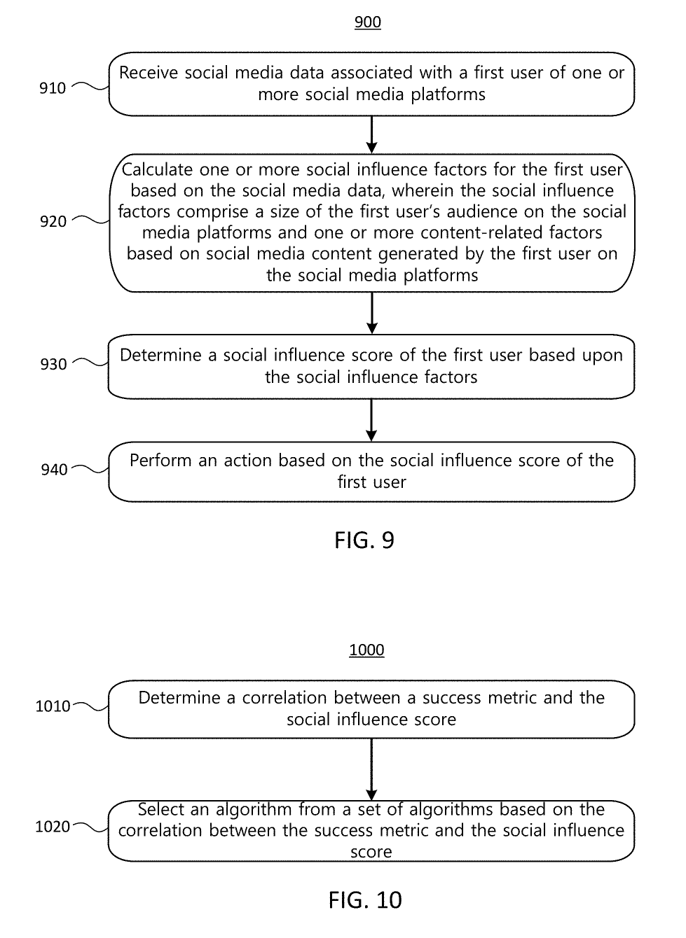

FIG. 9 illustrates an example method 900 for quantifying social influence and performing actions based on the quantified social influence. The method 900 may begin at step 910, where the social-networking system 160 may receive social network data associated with a first user of one or more social-networking systems 160. The social network data may include a set of data items, each based on a social media activity occurring in the social-networking system associated with the social network data. Each of the activities may identify an acting user, an action performed by the acting user on the social-networking system, and, optionally, an object upon which the action is performed. The object may be a social media content object (or other entity in the social-networking system). The acting user may be the first user, and the action may be generating the content object (or an action appropriate to the entity). At step 920, the social-networking system 160 may calculate one or more social influence factors for the first user based on the social network data. The social influence factors may include a size of the first user's audience on the social-networking systems 160 and one or more content-related factors based on social media content generated by the first user on the social-networking systems 160. At step 930, the social-networking system 160 may determine a social influence score of the first user based on the social influence factors.

At step 940, the social-networking system 160 may perform an action based on the social influence score of the first user. For example, the social-networking system 160 may determine whether there is a correlation between how the user's content is presented or positioned and the social influence score. Promotional content published on certain web sites may cause an increase in the social influence score, and the same content published on other web sites may cause a decrease in the social influence score. As another example, differently-phrased or differently-displayed variations of content published on the same web site may cause different changes in the social influence score. Other factors may be used to evaluate whether content is correlated to the social influence score, such as to whom who (e.g., which users, user demographic, user interest group, or the like) notifications related to the content are sent, to whom the content is displayed as an article, the time and date the content is published, and the like. When a correlation between how the user's content is presented and the social influence score is identified, the presentation or positioning of the content may be adjusted accordingly, e.g., so that the social influence score increases or at least does not decrease. For example, if publishing content on certain web sites causes an increase in the user's social influence score, then the content may be published again on those web sites in the future. If publishing at certain times causes the social influence score to decrease by a threshold amount, e.g., 20%, 30%, 50%, or the like, then the content may not be published at those times in the future.

In particular embodiments, the action performed at step 940 may include using the social influence score to measure progress made by a social network operator or user toward a goal, such as having a given number of public figures on a social-networking system who each have one million fans. The progress of a particular social networking system towards the goal can be tracked and compared to the progress of other social networking systems by comparing the overall scores of the two systems and also by comparing each of the four factors that make up the overall scores of the two systems. The social influence score may be used by a social-networking system operator to assess new features of the social-networking system, e.g., by investing more in certain dimensions that correspond to particular factors in order to outperform other social networking systems in those dimensions. For example, if a particular social networking system scores highly among a high-popularity group of users, but does not score as highly among medium- and low-popularity groups, then the operator of the social networking system may make an effort to reach out to emerging talent and bring them to the social networking system as content publishers. The social influence score may also be used to identify categories, such as industry verticals, geography, or demographic in which a particular social networking system is lagging behind others, and make adjustments. For example, an effort may be made to reach out to teenagers on a particular social networking system if social influence scores are being reduced by social influence factors that are based on behavior of teenage users.

In particular embodiments, the action performed at step 940 may include using the social influence score to increase the social influence of a user. The social influence score can be used to assist users in promoting their brand, their merchandise, and the like. Users may observe how their score changes over time, and may change the social network configuration (e.g., by enabling comment ranking) or change their own marketing approach (e.g., by holding more events, advertising more with the social-networking system, and so on) based on how their social influence score varies over time. The users may correlate the score to their own marketing methods. If their marketing methods are not producing desired results, then the social-networking system may determine why their score is going down (e.g., which factor of the score is decreasing on which social-networking systems), implement a plan for how to improve the score, and monitor the score to determine whether the plan results in improvements.

In particular embodiments, the action performed at step 940 may include using the quantified social influence score to evaluate other actions to determine whether the other actions lead to increases or decreases in the user's social influence, and to repeat or emphasize the actions that lead to increases. A user's social influence score may be increased by identifying the social influence factors and/or social-networking systems having that are causing the score to be lower than desired or lower than a threshold or average score. For example, the social influence factor having the lowest value of the social influence factors used in the social influence score calculation may be identified as a factor to be improved. When a particular factor has been identified for improvement, the aspects of social influence measured by that factor may be adjusted by the user or by the social networking system. The social networking system may identify one or more adjustments to the aspects of the user actions or content that are measured by the identified factor. The identified adjustments may be suggested to the user or social network operator, and may include suggesting best practices to low-scoring users, such as practices used by higher-scoring users.

In particular embodiments, the action performed at step 940 may include making identified adjustments to the social-networking system 160, such as providing or enabling additional features that can be used to improve the score. For example, if the social networking system does not allow users to see high quality comments by ranking because the comment ranking feature is disabled or not available on the social networking system, then the system may suggest that comment ranking be enabled or otherwise provided on the system.

In particular embodiments, the action performed at step 940 may include using the social influence score to improve monetization of content or of user actions on the social-networking system. Influential users may have large fan followings and correspondingly large opportunities for monetization. The social-networking system may identify a correlation between a user's social influence score and advertisement revenue. This correlation may be used to monitor a user's monetization indirectly by monitoring the user's social influence score. In this way, the user's actions, e.g., advertisement strategy, may be changed so that the score does not suffer as a result of advertisements. If displaying advertisements in association with a user's content correlates to a reduced social influence score (compared to other social-networking systems) then that user's advertisements or advertisement targeting approach may be changed.

In particular embodiments, the action performed at step 940 may include using the social influence score to improve advertisement monetization for a user. The social-networking system may allow users to enable social network advertisements on their pages. In addition, an option can be provided to enable a user to show advertisements as long as the user's social influence score does not fall, or does not fall below a threshold value, or as long as the user's monetization results satisfy a threshold value for a particular social influence factor of the social influence score.

In particular embodiments, the action performed at step 940 may include using the social influence factors to help public figures or other users connect with their audiences. Since the components of the score may be along different dimensions, geographies and verticals, the score may inform users where they are connected to audiences and where they are not connected, and how deep the connection is. These indicators may help users connect to their audience in different ways. For example, some users may want to improve their popularity among teenagers. Other users may want to improve their popularity only among users who like musicians' pages. The social-networking system may suggest to the user that he or she target a specific audience, e.g., teenagers or users who like musicians' pages. The social-networking system may provide the total number of users who like musicians' pages to the user and/or use that total number as a goal for the number of users who view one or more of the user's advertisements. The social influence score may be based on an advertisement viewer count factor that is proportional to the number of users who view the user's advertisements. A view count factor of 1.0 may correspond to a goal in which every user who likes musicians' pages views one or more of the user's advertisements. In this way, the social influence score may be used to help users measure and increase the degree of their connection to their audiences.

In particular embodiments, the action performed at step 940 may include using the social influence score to promote a user's brands or branded products. For example, the user may promote a line of jewelry to a specific segment of social-networking system users. The user may post a description of the jewelry and its benefits, and publish other information to promote the product. The user may determine his or her social influence score for a geographic region or vertical, such as India or Brazil, or other geographic area, and a count of the number of other users who are buying or talking about the product in the same region or vertical, but for a competing or different musician. The user may thus identify opportunities to improve using the score, and optimize for promotions in different dimensions.

In particular embodiments, the action performed at step 940 may include actions to increase or maintain a user's social influence score. For example, when displaying content or an advertisement in a user's news feed, the social networking system may monitor the user's social influence score and, in response to a decline in the score exceeding a threshold, e.g., a decline of at least 0.5 percentage points, replace the content with content of a different topic, or replace the advertisement with a different advertisement. This refinement process may be performed repeatedly, so that the content or advertisements are updated in response to changing conditions over time. As an example and not by way of limitation, a user may specify a range of values beyond which the overall social influence score should not fluctuate, e.g., between two numbers, or threshold minimum score the social influence score should fall below, e.g., 0.5, or less than a threshold amount per day, such as less than 2% in a day. Fluctuations greater than the threshold may cause an action such as replacement of an advertisement with a different advertisement. Fluctuations in some dimensions or verticals may be more acceptable than in others. For example, higher quality, more targeted advertisements may be preferred over lower quality and more general advertisements.

In particular embodiments, a marketplace influence score may be determined that quantifies the influence of sellers or buyers in commercial transactions. Marketplace influence of a buyer or seller may be in the form of buying or selling, or writing reviews. Marketplace influence may be based on how many products a business advertises or publishes, the inventory of products shown each day, how many customers interact with the business, how many customers leave positive feedback versus negative feedback, a star rating of the business, how many users have bought from the business in the past, or other factors that quantify a business's influence on a market. Another factor that quantifies the influence of commercial transactions may be the value of the transactions, e.g., in dollars, total number of volume of goods, or total number or value of transactions performed. Factors that are more important may be weighted higher than factors that are less important in quantifying commercial influence. As an example and not by way of limitation, the social influence factors may have corresponding marketplace influence factors, which may be used to calculate a marketplace influence score for a business, user, or other entity.

In particular embodiments, the number of customers or buyers that the business is connected to in the social-networking system may be used as a factor analogous to the fan popularity factor. The customers or buyers may be users who are friends of or follow the business, for example. The inventory of the business, and how many social network posts the business generates, may be used as factors analogous to the content publishing factor. Customer feedback, e.g., ratings, comments, and the like, may be used as a factor analogous to the content interaction factor. Ratings, reviews, or other assessment of the quality of the business's product or service may be used as factors analogous to the content quality factor. The total volume or dollar value of the business's transactions over a period of time may be used as another factor. The dollar volume may include the value of follow-on transactions. For example, even if no money is paid by users when they subscribe to a channel or follow the business on the social-networking system, the number of users that subscribe may be considered a follow-in transaction and included in the total volume or value of the business's transactions.

Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for quantifying social influence and performing actions based on the social influence including the particular steps of the method of FIG. 9, this disclosure contemplates any suitable method for quantifying social influence and performing actions based on the social influence including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

FIG. 10 illustrates an example method 1000 for selecting a social-influence scoring algorithm. The method 1000 may begin at step 1010, where the social-networking system 160 may determine a correlation between a success metric and the social influence score. At step 1020, the social-networking system 160 may select a social influence scoring algorithm from a set of algorithms based on the correlation between the success metric and the social influence score. The method 1000 may correspond to the method 3140 for generating social influence scoring algorithms shown in FIG. 3B.

Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for selecting a social-influence scoring algorithm including the particular steps of the method of FIG. 10, this disclosure contemplates any suitable method for selecting a social-influence scoring algorithm including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

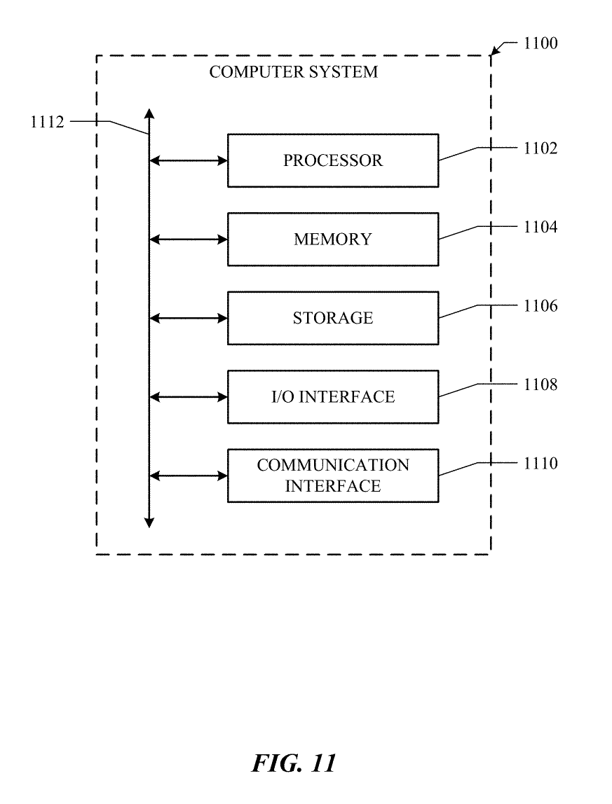

FIG. 11 illustrates an example computer system 1100. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing device, receiving social network data associated with a first user of one or more social-networking systems;
by the computing device, calculating one or more social influence factors for the first user based on the social network data, wherein the social influence factors comprise a size of the first user's audience on the social-networking systems and one or more content-related factors based on social media content generated by the first user on the social-networking systems;
by the computing device, determining a social influence score of the first user based upon the social influence factors; and
by the computing device, performing an action based on the social influence score of the first user.

2. The method of claim 1, wherein the social network data comprises one or more sizes of the first user's audience on each of the corresponding social-networking systems, each of the audience sizes is based on how many followers the first user has on each of the corresponding social-networking systems, and the size of the first user's audience is based on a sum of the audience sizes.

3. The method of claim 1, wherein the social media content comprises one or more posts, comments, articles, blog entries, links, status updates, photos, videos, audio recordings, or a combination thereof.

4. The method of claim 1, wherein the social network data comprises one or more sizes of the social media content generated by the first user for the first user's audience on each of the corresponding social-networking systems, and the content-related factors comprise a content publishing factor based on a sum of the sizes of the social media content generated by the first user.

5. The method of claim 4, wherein the social network data comprises one or more sizes of the social media content generated by the first user's audience for the first user on each of the corresponding social-networking systems, and the content-related factors further comprise a content interaction factor based on a sum of the sizes of the social media content generated by the first user and the sizes of the social media content generated by the first user's audience.

6. The method of claim 1, wherein the social network data comprises at least a portion of the social media content generated by the first user, and the content-related factors comprise a content quality factor that is determined based on a measure of quality of the social media content generated by the first user.

7. The method of claim 6, wherein the content quality factor is based on one or more of whether the content is promotional, a measure of authenticity of the content, a measure of richness or depth of the content, or a combination thereof.

8. The method of claim 1, wherein the social influence score of the user is determined by a scoring algorithm.

9. The method of claim 8, wherein the scoring algorithm determines the social influence score based on a weighted average of the social influence factors.

10. The method of claim 9, wherein the scoring algorithm determines one or more weights for the weighted average based on the first user's audience size.

11. The method of claim 9, wherein the scoring algorithm determines each of the social influence factors based on a weighted average of corresponding per-social-networking system social influence factors that are determined for each of the social-networking systems.

12. The method of claim 11, wherein the weight of each social-networking system is proportional to a number of users associated with the social-networking system.

13. The method of claim 1, further comprising:
by the computing device, determining a correlation between a success metric and the social influence score; and
by the computing device, selecting the algorithm from a set of algorithms based on the correlation between the success metric and the social influence score.

14. The method of claim 13, wherein the success metric is based on one or more success factors, and each success factor is associated with a time for which the success factor is determined.

15. The method of claim 1, wherein the action comprises:
determining a correlation between advertisement content presented in association with the first user on the one or more social-networking systems and the social influence score; and
changing the advertisement content when presentation of the advertisement content is correlated with a decrease in the social influence score.

16. The method of claim 15, wherein the action further comprises:
changing a configuration of the one or more social-networking systems when presentation of the advertisement content is correlated with a decrease in the social influence score.

17. The method of claim 16, wherein changing the configuration comprises enabling comment ranking or changing a marketing approach.

18. The method of claim 1, wherein the action comprises identifying one or more of the social influence factors that are associated with a subset of the user's audience, and targeting advertisements to the subset when each of the social influence factors satisfies a corresponding threshold condition.

19. One or more computer-readable non-transitory storage media embodying software that is operable when executed to:
receive social network data associated with a first user of one or more social-networking systems;
calculate one or more social influence factors for the first user based on the social network data, wherein the social influence factors comprise a size of the first user's audience on the social-networking systems and one or more content-related factors based on social media content generated by the first user on the social-networking systems;
determine a social influence score of the first user based upon the social influence factors; and
perform an action based on the social influence score of the first user.

20. A system comprising: one or more processors; and a memory coupled to the processors comprising instructions executable by the processors, the processors being operable when executing the instructions to:
receive social network data associated with a first user of one or more social-networking systems;
calculate one or more social influence factors for the first user based on the social network data, wherein the social influence factors comprise a size of the first user's audience on the social-networking systems and one or more content-related factors based on social media content generated by the first user on the social-networking systems;
determine a social influence score of the first user based upon the social influence factors; and
perform an action based on the social influence score of the first user.
